(19) United States
(12) Patent Application Publication
(10) Pub. No.: US 2023/0186093 A1
(43) Pub. Date: Jun. 15, 2023

(54) SYSTEMS AND METHODS FOR TRAINING AND/OR DEPLOYING A DEEP NEURAL NETWORK

(71) Applicant: InterDigital CE Patent Holdings, Paris (FR)

(72) Inventors: Quang Khanh Ngoc Duong, Rennes (FR); Thierry Filoche, CHATEAUGIRON (FR); Francoise Le Bolzer, RENNES (FR); Francois Schnitzler, Saint Avé (FR); Patrick Fontaine, RENNES (FR)

(73) Assignee: InterDigital CE Patent Holdings, Paris (FR)

(21) Appl. No.: 17/924,054

(22) PCT Filed: May 5, 2021
(86) PCT No.: PCT/EP2021/061798

§ 371 Date: Nov. 8, 2022

(30) Foreign Application Priority Data
May 12, 2020 (EP) 20305485.3

(51) Int. Cl. G06N 3/082; G06N 3/0455

(52) U.S. Cl. CPC G06N 3/082; G06N 3/0455

(57) ABSTRACT

The present disclosure relates to a method including obtaining metadata upon training a first Deep Neural Network and embedding the obtained metadata in a signal. The present disclosure relates to a method including obtaining metadata related to a prior training of a first Deep Neural Network and adapting a model of a second Deep Neural Network using the obtained metadata. The present disclosure also relates to the corresponding devices, computer storage medium and signal.

### INTRODUCTION

The domain technical field of the one or more embodiments of the present disclosure is related to the use of Deep Learning techniques, like a use of a Deep Neural Network (DNN). As Deep learning techniques can be used in many technical fields, embodiments of the present disclosure can be implemented in many technical fields, for instance in the technical domain of multimedia processing, like for instance in image processing, video processing and/or audio processing.

### DESCRIPTION

According to a first aspect, the present principles enable at least some disadvantages to be resolved by proposing a method for training a Deep Neural Network.

At least some embodiments relate to storing/ encoding / transmitting/ decoding, metadata related to a training of a Deep Neural Network. The metadata can be associated to the DNN as side information or can be stored/ encoded / transmitted/ decoded separately to the model they relate to.

At least some embodiments relate to encoding/decoding metadata related to a training of a Deep Neural Network and/or to parameters of the DNN model output by the training.

At least some embodiments of the present disclosure propose a method for encoding a Deep Neural Network.

At least some embodiments of the present disclosure propose a method for decoding a Deep Neural Network.

At least some embodiments of the present disclosure relate to a device comprising at least one processor configured for obtaining at least one metadata determined from a prior training of a first Deep Neural Network (DNN); and adapting a model of a second Deep Neural Network using said obtained metadata.

At least some embodiments of the present disclosure relate to a method comprising obtaining at least one metadata from a prior training of a first Deep Neural Network and adapting a model of a second Deep Neural Network using said obtained metadata.

According to at least some embodiments of the present disclosure, the metadata belong to a group comprising:
at least one batch size,
at least one optimizer,
at least one drop-out setting,
at least one learning rate setting,
a designation and/or a parameter of at least one loss function,
at least one performance indicator related to the accuracy of training;
at least one indicator related to an importance of at least one weight or at least one filter of at least one layer of the DNN;
at least one information regarding one or more pre-processing performed on at least one element of a training set used during said training
at least one information related to one or more mode(s) of operation of the DNN Model
at least one information representative of at least one position inside the DNN model where a prediction can be made;
a combination of at least two of the above metadata.

According to at least some embodiments of the present disclosure, said adapting comprises fine-tuning said model using said first metadata.

According to at least some embodiments of the present disclosure, said adapting comprises pre-processing at least a part of a training data set used during said fine -tuning.

According to at least some embodiments of the present disclosure, said adapting comprises dropping at least a part of said model using said first metadata.

According to at least some embodiments of the present disclosure, said adapting can include model adaptation by further training and/or model configuration to select the required/optimal operating point for inference.

According to at least some embodiments of the present disclosure, said second DNN is said trained first DNN and said first metadata and said model are obtained separately.

According to at least some embodiments of the present disclosure, said second DNN is said trained first DNN and wherein said first metadata is obtained as side information of said model.

According to at least some embodiments of the present disclosure, the at least one processor is adapted for, or the method comprises, rendering at least one information representative of one or more of said metadata on a user interface.

While not explicitly described, the above devices can be adapted to perform the above methods of the present disclosure in any of their embodiments.

According to at least some embodiments of the present disclosure, said adapting comprises loading a subset of said model using said first metadata. For instance, said subset model can be related to compute power, chipset architecture, power saving constraints, or latency constraint.

For instance, at least one embodiment of the method of the present disclosure relates to a method for decoding metadata related to a prior training of a first DNN and/or and training a second DNN Deep Neural Network, for instance fine tuning parameters of the second Deep Neural Network.

Generally, in an encoding process, data are entropy coded to obtain compressed data. To reconstruct data, the compressed quantized data are decoded by inverse processes corresponding to the entropy coding and quantization.

According to another aspect, there is provided an apparatus. The apparatus comprises a processor. The processor can be configured to train, encode and/or decode metadata related to a Deep Neural Network and /or to train, encode and/or decode a Deep Neural Network by executing any of the aforementioned methods.

According to another general aspect of at least one embodiment, there is provided a device comprising an apparatus according to any of the decoding embodiments; and at least one of (i) an antenna configured to receive a signal, (ii) a band limiter configured to limit the received signal to a band of frequencies that includes a part of the signal, or (iii) a display configured to display an output representative of a part of the signal.

While not explicitly described, the present embodiments related to the methods or to the corresponding devices can be employed in any combination or sub-combination.

According to another aspect, the present disclosure relates to a non-transitory computer readable program product comprising program code instructions for performing, when the non-transitory computer readable program product is executed by a computer, at least one of the methods of the present disclosure, in any of its embodiments.

According to another aspect, the present disclosure relates to a non-transitory computer readable storage medium carrying a software program comprising program code instructions for performing, when the software program is executed by a computer, at least one of the methods of the present disclosure, in any of its embodiments. According to another general aspect of at least one embodiment, there is provided a non-transitory computer readable medium containing data content generated according to any of the described encoding embodiments or variants.

According to another general aspect of at least one embodiment, there is provided a signal comprising data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

### BRIEF DESCRIPTION OF THE DRAWINGS

FIG. 1 shows a generic, standard encoding scheme.

FIG. 2 shows a generic, standard decoding scheme.

FIG. 3 shows a typical processor arrangement in which the described embodiments may be implemented;

FIG. 4 illustrates a DNN encoding scheme according to at least some embodiments of the present disclosure;

FIG. 5 illustrates a DNN decoding scheme according to at least some embodiments of the present disclosure;

FIGS. 6A to 6C show some exemplary workflows of the framework proposed by the present disclosure;

FIGS. 7A and 7B show some exemplary embodiments of methods of the present disclosure for obtaining and /or using metadata;

FIG. 8 shows exemplary use and extraction of metadata, implemented at different levels of development and deployment of a DNN.

It is to be noted that the drawings illustrate example embodiments and that the embodiments of the present disclosure are not limited to the illustrated embodiments.

### DETAILED DESCRIPTION

Deep Neural Networks (DNNs) have shown state of the art performance in variety of domains such as multimedia processing, computer vision, speech recognition, natural language processing, etc. This performance however can come at the cost of massive computational cost as DNNs tend to have a huge number of parameters often running into millions, and sometimes even billions.

In order to obtain a good machine learning model, more specifically a deep neural network (DNN) model, researchers and engineers spend a huge amount of time in experimenting different model architectures, settings of parameters, like “hyperparameters”, pre-processing methods, and so on. By “hyperparameter” it is to be understood herein a parameter, other than the ones describing the DNN itself (like weights (or neurons) of layers of the DNN) but related to the way the DNN has been trained , fine-turned, or validated (inference).

Users of a Deep Neural Network models, or device or application using one or more Deep Neural Network model, have usually no idea about how models were trained. As a consequence, training a DNN model and/or deployment of a trained DNN often cannot rely on information and/or knowledge that were available during the training stage of such models and would have been useful at a later stage (like Re-training or fine tuning).

At least some embodiments of the present disclosure propose to keep at least a part of the knowledge related to the training of a model, like training parameters and application metrics. For instance, during the training, various useful knowledge concerning the model can be observed such as the evolution of loss function, accuracy, gradient variation, etc. Such knowledge can be saved in or retrieve from analog and/or digital information, representative of such knowledge, that can be recorded on a storage medium and/or embedded in a signal. The representative information (also called herein metadata) can be saved on a computer readable medium and/or encoded and/or transmitted to facilitate the deployment of at least one DNN-based model. For instance, some representative information can be helpful to fine-tune, transform, adapt, and/or personalize a DNN model for a new context and/or for a new application (e.g. to adapt a DNN to a local environment, like the Operating System and/or the processing capabilities of a device, or to personalize a DNN by fine tuning, thanks to personal, private, data like images of member(s) of a family).

It is to be pointed out that, depending upon embodiments, the representative information can be stored/encoded/transmitted/decoded either in association with parameters of a DNN (e.g. as side information) or separately (for instance in the purpose of using some information representative of an architecture or a training phase of a first DNN for designing and/or training a second DNN).

At least some embodiments of the present disclosure can thus help to exploit those representative information afterwards, like when models are deployed in a device other than the one where the training was performed.

Depending upon embodiments, the representative information can be used at different stages, and differently as illustrated by the exemplary embodiments detailed herein after.

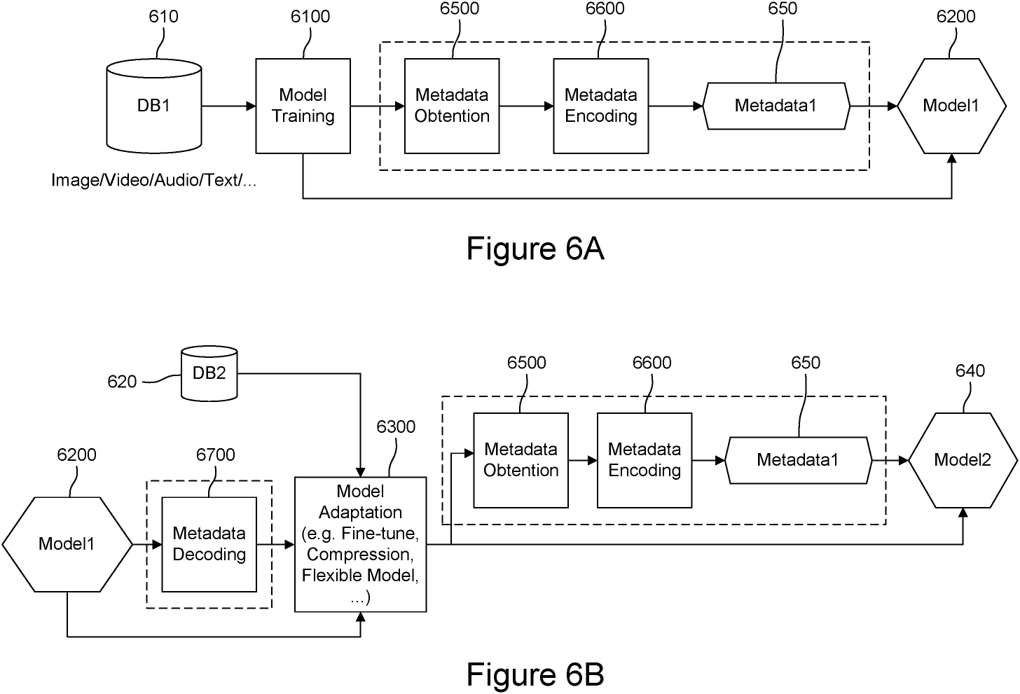

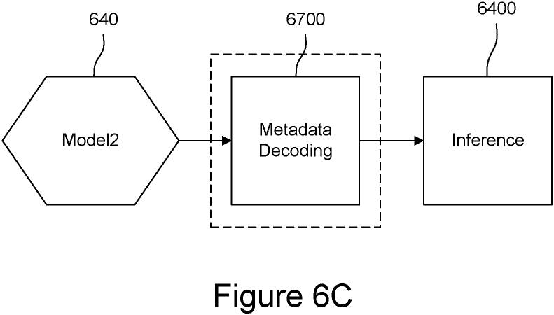

A high-level workflow (training and deployment) of an exemplary machine learning system according to least one embodiment of the present disclosure is shown in FIGS. 6A to 6C. Such a workflow can allow to take into account information used and/or collected during a training phase (as illustrated by FIGS. 6A to 6C) at a later stage.

More precisely, according to the exemplary embodiments of the system of FIGS. 6A and 6C, metadata (block 6500) can be obtained (for instance extracted) from information generated and/or collected upon training DNN models (before and/or during training of a model and/or from the output of the training) and/or optionally encoded (like block 6600), for a later use.

The metadata can be used in the deployment phase as shown in FIG. 6B, optionally after being decoded (like block 6700). For instance, they can be used for model adaptation during the model deployment phase (like block 6300).

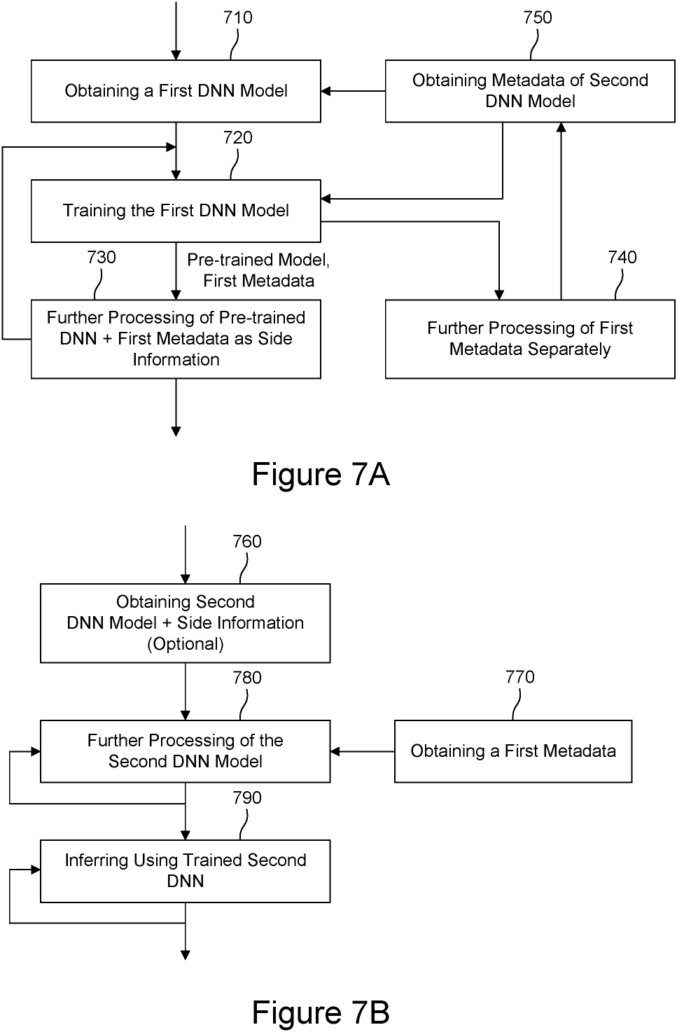

More details about each block in the workflow are given below in link with FIGS. 6A to 6C and FIGS. 7A and 7B.

FIG. 6A notably illustrates the training and encoding of a first DNN in an exemplary use case. FIG. 7A illustrates, in link with the first DNN of FIG. 6A, at least one method of some embodiments of the present disclosure that can be implemented in an electronic device (like a cloud device, or an encoding device). As illustrated, the method of FIG. 7A can comprise obtaining 710 a first DNN model (i.e. a DNN architecture from which training (as illustrated by block 6100 of FIG. 6A) is performed). The obtaining of the first model can comprise designing the first DNN model or re-using an already designed (or partially designed) first DNN model. The architecture can for instance be initialized (e.g. initializing weight values) from a “on-the-shelf” model or randomly.

The method of FIG. 7A can also comprise training 720 the obtained first model (as illustrated by block 6100 of FIG. 6A). The training can for instance involve using one or more elements stored in at least one first file (like a database as illustrated by element DB1 of block 610 of FIG. 6A). The elements can be in the form of audio, image, video, text, time series, etc.

Depending upon embodiments, the training can be performed differently. For instance, it may depend on a task or a plurality of tasks that are to be assigned to the DNN during its operation (i.e. during inference).

The training of the first model results in a pre-trained first model (block 6200 of FIG. 6A) and a number of metadata related to the training of the first DNN model. The metadata can have been obtained, for instance generated and/or extracted from the first DNN model, and memorized, during the training of the first model, or can have been obtained during an earlier stage (like during a design of the first model) or can have been output by a prior training of another (“second”) DNN model (for instance using the method, illustrated by FIG. 7A, of the present disclosure). Optionally, as illustrated by Block 6600 of FIG. 6A, the obtained metadata can be encoded. The metadata can further be processed (730, 740), for instance they can be transmitted and/or saved for future uses. As illustrated by the FIG. 7A, the metadata can be associated to the pre-trained first model as side information (as illustrated by FIGS. 6A and 6B) for further processing 730 or can be kept, separately from the pre-trained first model for further processing 740 (for being used for training another DNN model for instance).

Thus, in some embodiments, the method can comprise obtaining 750 metadata of another model, like training metadata. It is to be pointed out that as training of a DNN can be performed several times, the “other” model can be a prior version of a same DNN, in other words a model obtained by updating (thanks to a prior training) a model of a same DNN. In such an embodiments, the first metadata output by the training of the “first” model can include at least a part of the metadata related to the prior training.

Depending upon embodiments, different kinds of metadata can be obtained. Examples of metadata include:
indication related to a setting of one or more of parameters (also called herein “hyperparameters”) used during the training of at least one DNN model, like one or more batch size (in other words a number of samples used to compute gradient in an iteration), one or more parameter relating to optimizer settings, drop-out settings, learning rate settings, one or more loss function, one or more evaluation metrics, and so on.

For instance, for a flexible Recurrent Neural Network (RNN) training, one can train the network using different loss function conditions. As an example, in a first step, a looser loss function condition can be used to converge to a model and then this model can be trained with a more binding condition. In that case, in order to keep information relating to the two-step trainings, the different loss function conditions can be stored. In another example, only the last loss function condition can be stored.
one or more importance indicator related to an importance of at least one weight (or neuron) in the DNN. The way such an importance indicator can be defined can vary upon embodiments. For instance, an importance indicator regarding at least one weight (or neuron) can be computed based at least partially on a variation of a value of the at least one weight (or neuron) during the training of the DNN, and/or based at least partially on a contribution of the at least one weight (or neuron) in a loss function used during the training of the DNN, or based at least partially on a contribution of the at least one weight (or neuron) in an accuracy of at least one prediction, etc.
at least one information regarding one or more pre-processing methods used before the training the DNN, for instance methods applied to at least one element of the training set, such as data scaling, normalization, data transformation (e.g. image crop, rotate...), data augmentation method, etc.
at least one information related to one or more modes of operation of the model, for example different modes of operation with different accuracy, computational cost and/or memory footprint tradeoff. The information can be an information such as a designation of one of several modes, like deployment modes or a complementary information associated to a mode, on some other information related to deployment modes like an available computation resources or other constraints about inference time, memory requirement, accuracy, etc,
at least one information representative of at least one position in the network where a prediction can be made (thus allowing a device to drop any further computation of the DNN model after this position and thus use a “light” model), of different quantization, approximation or compression levels for the parameters, of additional layers, of part of the network that can be dropped to reduce accuracy, cost and footprint, of one or more different models of the same families with different tradeoffs etc.

As pointed out above, the metadata can be further processed 740 (e.g. encoded, stored on a record medium and/or transmitted) separately from the parameters of the DNN Network (as illustrated by Block 650 of FIG. 6A). The metadata can also be further processed 730 (e.g. encoded, stored on a record medium and/or transmitted) together with the model parameters (architecture, parameters) (as illustrated by Block 6200 of FIG. 6A). Depending upon embodiments, the signal used for transmitting the metadata can be coded using different formats. In some embodiments, the metadata can be encoded separately from the model parameters (e.g.in a dedicated file). In some embodiments, the metadata can be encoded together with the model parameters, for instance using an API or a format for saving and exchanging a Neural Network model like the Open Neural Network eXchange (ONNX) format and/ or the Neural Network Exchange Format (NNEF).

For instance, in some embodiments, where the signal is compatible with a ONNX format, metadata can be embedded in an extension of the ONNX format. According to another example, in some embodiments, where the signal is compatible with a NNEF format, metadata can be embedded as additional data, like in an extension to the initial container by addition of a file.

As an example based on a standard (like NNEF) where the contents of the container may consist of several files (e.g. container storing specific information in sub-folders and files, such as optimized network data in custom formats), and which introduces a textual file describing the structure of the network, a binary data file (structured according to Tensor File Format) for each variable tensor in the structure description, an optional quantization file (structured according to Quantization File Format) containing quantization algorithm details for exported tensors, metadata can be stored in an additional file containing specific metadata information. Example of further processing of metadata can include transmitting metadata to another electronic device, like an edge device or a device where the DNN network will be deployed (like a personal computer, a laptop, a smartphone, a tablet, a connected device and so on).

Transmitting the metadata can occur just after the training or later, after storing the metadata for a while in a storage medium after the training is finished.

FIG. 7B illustrates, in link with FIGS. 6B and 6C, at least one method of some embodiments of the present disclosure, that can be implemented in an electronic device (called herein “target electronic device”) like another cloud device, an edge device or a device where the DNN network will be deployed (like a personal computer, a mobile device, a laptop, a smartphone, a tablet, a connected device, CE devices (including smart TV, smart assistant, AI accelerator)) upon and/or after obtaining (e.g. receiving) metadata of the pre-trained first DNN model. FIG. 6B illustrates more specifically an exemplary use case in an “intermediate device”, where obtained metadata are used for a training of a DNN (either a training of another DNN or a further training of a same DNN as the one the received metadata are related to). FIG. 6C illustrates more specifically an exemplary use case where metadata are used for a fine-tuning of a DNN before inference in a “target device” (in other words for obtaining a fine-tuned DNN (Model2 block 640) to process inference).

The method of FIG. 7B can comprise obtaining 770 first metadata related to a first DNN model and obtaining 760 a second DNN model (for instance the trained first DNN model which training has output the received metadata or a model other than the trained first DNN model).

The first metadata and /or the second DNN model can be obtained from a storage medium or from a signal received by the target device.

Depending upon embodiments, the obtaining of the first metadata or the obtaining of the second DNN model can be performed separately, or the first metadata can be obtained jointly with the second DNN model (for instance as side information when the first DNN and second DNN are the same). In some embodiments, some metadata can be obtained jointly with the second DNN model, other metadata being obtained separately (or independently) of the second DNN model.

Optionally, as illustrated by block 6700 of FIGS. 6B and 6C, the method can comprise decoding, eitherjointly or separately, the obtained metadata and/or the obtained model. The method of FIG. 7B can also comprise processing 780 the obtained second model using some of the obtained first metadata. For instance, an intermediate adaptation including optionally compression and/or decompression of the model can be performed. The processing 780 can involve a training of the second DNN model using one or more elements stored in at least one file (like a database as illustrated by element DB2 of block 620 of FIG. 6B). The elements can be in the form of audio, image, video, text, time series, for instance. Depending upon embodiments, the training 780 can be performed differently. For instance, it may depend on a task or a plurality of tasks that are to be assigned to the DNN on the electronic device.

In some exemplary embodiments, (implemented for instance in an intermediate device like an edge device), the first metadata and/or the second DNN model can be loaded for model adaptation (block 6300) (e.g. fine-tuning of the model).

In the exemplary use case of FIG. 6B where the second DNN model is the trained first model (Model 1), the trained first model is fined tuned using the first metadata. After fine-tuning, we obtain a second DNN model and second metadata.

Indeed, applications based on deep leaning technics can require the adaptation of models to different tasks, to different conditions or to optimize the performance (computation cost) of at least one targeted device. The fine-tuning 780 can use fewer elements (of DB2 for instance) than the elements (of DB1 for instance) used for the pre-training 720 of the first DNN model. Metadata 6500 obtained during the fine-tuning (including the first metadata) can thus be optionally compressed (like encoded as illustrated by block 6600) and/or transmitted to one or more target device(s) (as shown by blocks 640, 650 of FIG. 6B, similarly to what has already been explained above in link with FIGS. 6A and 7A.

In the exemplary use case of FIGS. 6C and 7B, implemented for instance in a target device, the method can involve an inference (6400, 790) of the DNN model. Even if not illustrated by FIG. 6C, it is to be understood that in some embodiments, a model adaptation can also be performed in the target device (for instance personalization of the DNN using private information of a user of the target device like family members images and/or audio samples).

In some exemplary use cases, model adaptation (either in an intermediate or target device) can involve (as illustrated by block 6300 of FIG. 6B) fine-tuning a DNN model with a new dataset (like DB2 in FIG. 6B). In some exemplary use cases, model adaptation can involve model compression or pruning. Model adaptation can also comprise splitting the model in several parts, that can be later deployed on different devices. Such embodiments can be of interest to accelerate inference time and save memory, by splitting computations between different devices. According to some embodiments of the present disclosure, model adaptation can take into account, further to the layer structure of the DNN and the weights and biases of the layer, some metadata related to the training.

Examples of such metadata include one or more hyperparameter(s) related to a prior training. The use of the metadata during model adaptation can be automatic (when metadata are used as input parameters of a software application for instance) or, in some embodiments, some information representative of the metadata can be provided on a user interface for instance. Indeed, the providing of an hyperparameter relating to some setting of a prior training of a model can help a user to choose, or adjust, some parameter settings upon fine-tuning a model with new/personalized data. In some embodiments, for instance when a pre-processing has been applied to data used during a prior training of a model, metadata related to the pre-processing methods can be useful in order to permit to pre-process similarly, fully automatically or under a control of a user, the data used during the adaptation and/or the fine-tuning of the model (or at least to obtain data of a similar type as the pre-processed data for the adaptation and/or fine-tuning).

Notably, at least a part of the parameters saved as metadata can be reused during the adaptation and/or the fine-tuning of the model.

Also, metadata relating to importance of some DNN weights can be helpful for a processing in link with the DNN weights. In some embodiments, for instance embodiments where the personalized data of the training set (like DB2) is not as big as the initial data (like DB1) used for training the model, fine-tuning can be only performed on a subset of the most important neurons of the DNN, rather than on the whole model weights.

In this case, the metadata related to the importance of the neurons can be helpful for determining (or selecting) the subset to be used for fine-tuning.

In some embodiments comprising reducing the model size (so as to be consistent with some computation/memory resource limitation of a device (like a cloud device, an edge device and/or a target device), the use of importance metadata can help pruning less important neurons to make the model lighter. Also, training metadata can help improving encoding efficiently (e.g. importance of neurons can be implemented as a ranked list).

As another example, metadata related to different modes of operations of a DNN model can help to adapt the DNN model to one or more requirement(s) of at least one task that the DNN is to be performed during inference, and to the devices where the DNN is deployed. Such requirements (or constrains) can include accuracy requirements, energy requirements, computational requirements and/or memory requirements. The metadata can be used for instance to select a model from a family of models, to pick a sub-part of the model, and/or to select a set of parameter settings.

Metadata can thus help to adapt the DNN model to a target device where the DNN will infer, for performance optimization or energy saving for instance.

The metadata obtained upon training a model can also be used upon encoding at least a part of the DNN parameters, (like during quantization and/or approximation of a weight of the DNN), upon dividing the model into different components to be executed on different device (therefore dividing computations between the devices) like a user equipment, edge and/or cloud devices.

Metadata of pre-trained NN models can thus help improving adaptation and/or flexibly during deployment of a DNN, while not significantly affect the overall size of the model (when associated as side information to the model).

The model adaptation can output an adapted model (as illustrated by block 640 of FIGS. 6B and 6C). The adapted model can be used for inference (i.e. performing a certain task) in a target device (e.g. any CE device like a smart TV, a mobile phone, a set-top-box...), in an edge device or in a cloud device ( or in a combination of such devices).

Model adaptation is illustrated in link with block 6300 of FIG. 6B. However, in some embodiments, model adaptation can be performed in a target device (as explained above) or in a cloud device. For instance, it can be performed offline in a cloud data center and the new model is saved for future use. The model can then be used for inference in the cloud data center or transmitted for use in Consumer Electronic (CE) devices during deployment.

In some embodiments, the model adaptation step (Block 6300) can be performed online in an edge device or in a cloud device, the new model being transmitted for immediate use, or directly in a CE device.

In some embodiments, the model adaptation can use the obtained metadata and can further obtain additional metadata (by implementing metadata extraction and/or metadata encoding) that can be added, saved and/or transmitted with the previous obtained metadata, together or separately with the adapted model.

Metadata can also for instance help meeting some potential service requirements for some Artificial Intelligence (Al)/Machine Learning (ML) model distribution, for instance service requirements to adapt a model to limited capacity computational and energy resources of a target device, or to update AI/ML models to adapt to changing tasks and environments.

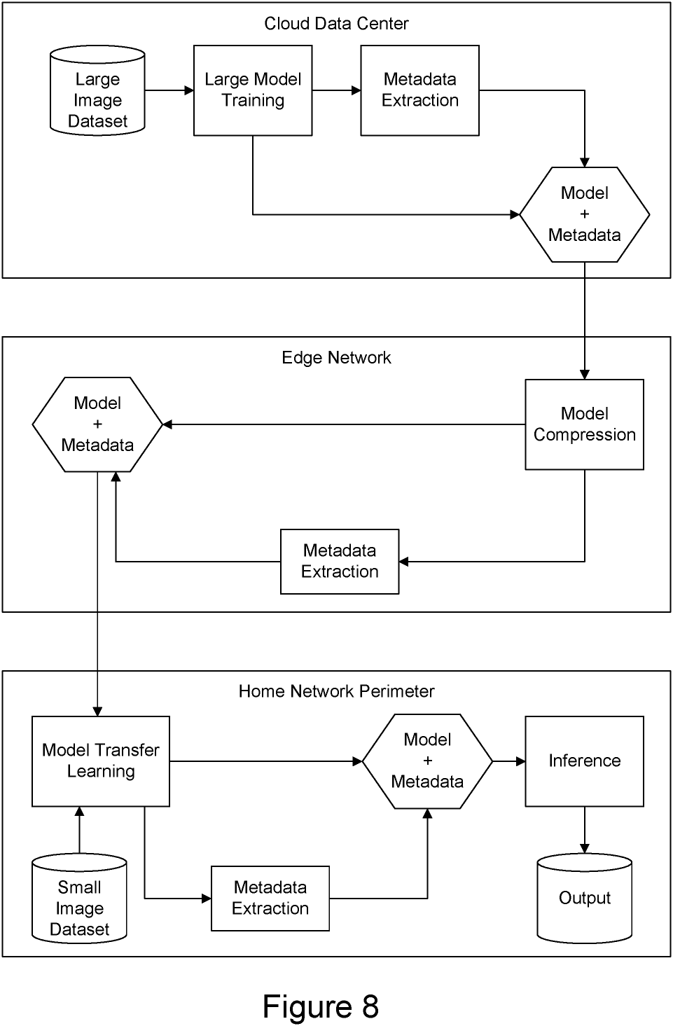

FIG. 8 illustrates an example of a deployment architecture of a communication network system, according to some embodiments of the present disclosure, with different levels of development and deployment of a DNN. The illustrated system comprises a cloud data center (for instance a cloud data centerwhere FIG. 6A can be implemented), an edge network (comprising one or more network devices) (for instance an edge network/ device where FIG. 6B can be implemented) and a home network (comprising at least one network device) (for instance home network / device where FIG. 6C can be implemented).

In the cloud data center, a first training of a DNN model is performed, metadata are extracted from the training and the trained model and the training metadata are input to the edge network, where they can be compressed (encoded and/or decoded) and transmitted to the home network. The home network can receive the metadata and the trained model, that can be used for Model Transfer Learning using a dataset smaller than the one used in the cloud data center. As illustrated, additional metadata can be obtained (extracted and/or generated) by the Model Transfer Learning. The adapted model output by the Model Transfer Learning and, optionally, the obtained metadata and the additional metadata can be used for inference of the DNN.

Of course, FIG. 8 is only an exemplary embodiment. In some other embodiments of the present disclosure, some block(s) illustrated in the cloud can be implemented in the edge and/or home network, and/or some block(s) illustrated in the edge can be implemented in the cloud and/or in the home network, and/or some block(s) illustrated in the home network can be implemented in the edge and/or in the cloud network (e.g. compression can be performed in the cloud or compression can be performed in the home network to fit a specific device).

It is also pointed out that depending upon embodiments sequential aspects of the training can be conserved or omitted. For instance, metadata can be added/removed/replaced at different steps in the architecture (thus metadata referring to the latest model training can coexist or not with metadata referring to the initial model).

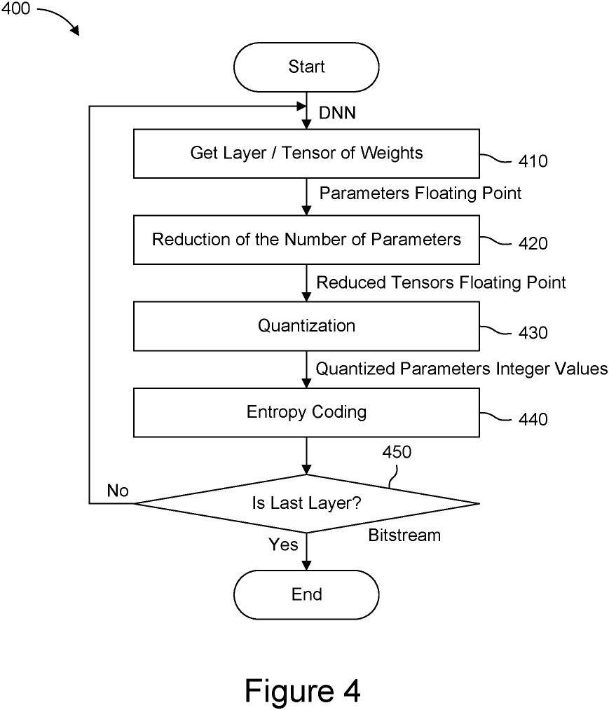

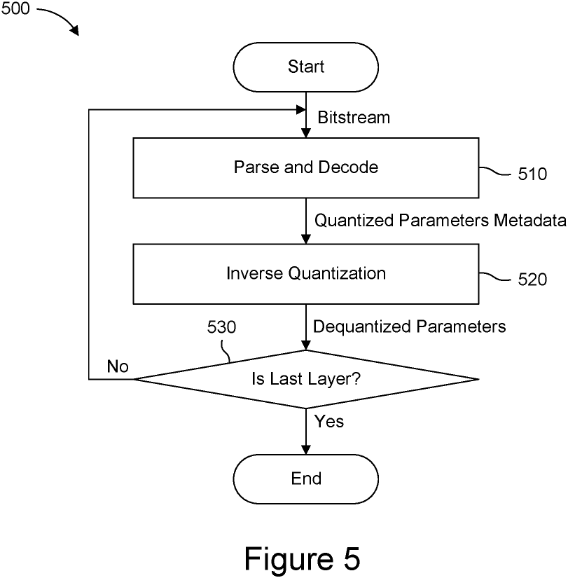

At least some embodiments of the present disclosure can comprise compression of at least some metadata related to a training of at least one DNN model. As explained above, depending upon embodiments, those metadata can either be stored, encoded, transmitted, and/or decoded as side information of the DNN model (for instance side information of data describing the architecture of the DNN and/or parameters (like weight and bias) of layers of the DNN. Compression of metadata (like training metadata) of the at least one DNN and/or their associated data can facilitate transmission and/or storage of the metadata and/or their associated data. FIGS. 4 and 5 illustrate a general workflow (that can be implemented in some exemplary embodiments of the present disclosure) encompassing compression of parameters of at least one tensor associated with at least one layer of the at least one Deep Neural Network. In some embodiments, the compression can be performed iteratively on two or more layers of a same DNN (as illustrated by FIGS. 4 and 5) and, notably, in some embodiments, on each layer of the same DNN.

Depending upon embodiments of the present disclosure, all the at least one layer can be convolutional layer(s), or fully connecter layer(s), or the at least one layer can comprise at least one convolutional layer and/or at least one fully connecter layer.

In the exemplary embodiment of FIG. 4, the method 400 can comprise obtaining 410 (or in other words getting) parameters of the tensor associated with a layer to be compressed. The obtaining can for instance be performed by retrieving the parameters of at least one layer from a storage unit, or by receiving the parameters from a data source via a communication interface.

In at least one embodiment of the present disclosure, performing a compression of a layer of a Neural Network can comprise:
Quantization 430 of parameters (like Weights and Biases) of the layer of the Neural Network to represent them with a smaller number of bits;
Lossless entropy coding 440 of the quantized information.

In some embodiments, the compression 400 can further comprise, prior to the quantization 430, a step of reducing 420 the number of parameters (like Weights and Biases) of the Neural Network by utilizing the inherent redundancies in the Neural Network. The reducing 420 thus provides a tensor of reduced dimensions, compared to the dimension of the tensor associated with a layer. This reducing 420 is optional and can thus be omitted in some embodiments.

FIG. 5 depicts a decoding method 500 that can be used for decoding a bitstream obtained by the method 400 already described in link with FIG. 4. As illustrated by FIG. 5, the decoding method 500 can comprise parsing and decoding 510 a bitstream corresponding to one or more layer of the DNN. More precisely, the parsing and decoding 510 can comprise decoding 512 the header part of the bitstream. The decoded header information, obtained by decoding the header, can comprise for instance parameter previously used for quantizing the values of the corresponding original tensor. The method 500 can further comprise decoding 514 the body of the bitstream.

When several layers can be decoded by the decoding method 500, the method 500 can be performed iteratively layer per layer, until (550) parameters of the last layer are encoded.

### Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

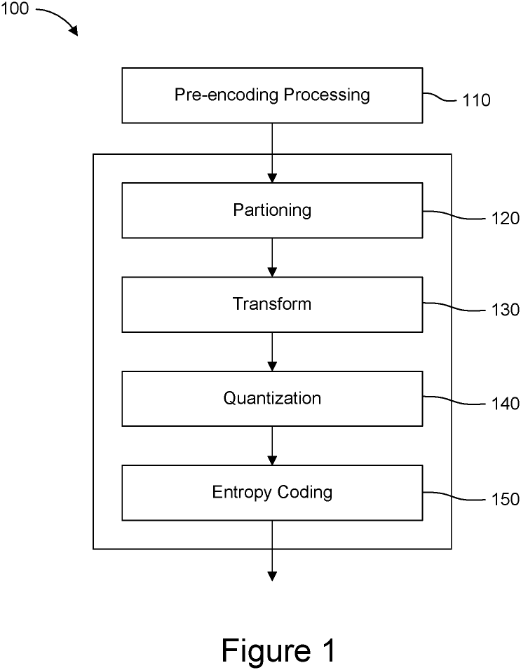

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to an encoding and decoding framework, that can be applied to encoding or decoding data related to a DNN, and at least one other aspect generally relates to transmitting a bitstream generated or encoded. These and other aspects can be implemented as a method, an apparatus, a computer readable storage medium having stored thereon instructions for encoding or decoding data, like data related to a DNN, according to any of the methods described, and/or a computer readable storage medium having stored thereon a bitstream generated according to any of the methods described.

In the present application, the terms “reconstructed” and “decoded” may be used interchangeably, Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

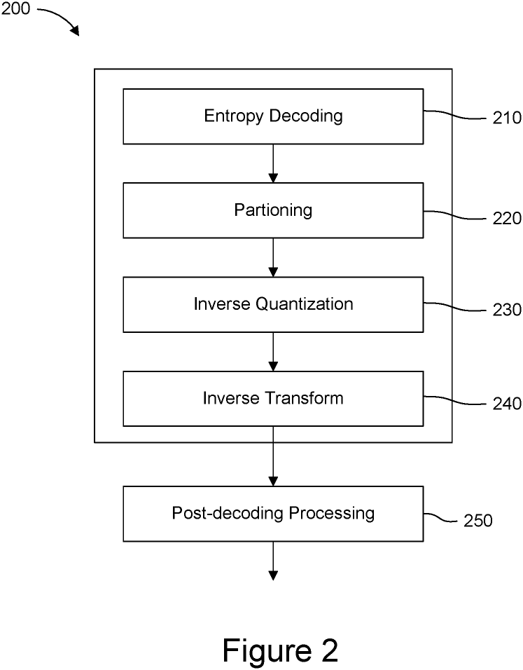

Various methods and other aspects described in this application can be used to modify modules, for example, entropy coding, and/or decoding modules (360, 150, 330), of an encoder 100 and a decoder 200 as shown in FIG. 1 and FIG. 2. Moreover, the present aspects are not limited to a given standard and can be applied, for example, to other standards and recommendations, whether pre-existing or future-developed, and extensions of any such standards and recommendations. Unless indicated otherwise, or technically precluded, the aspects described in this application can be used individually or in combination.

Various numeric values are used in the present application (for example regarding importance metric). The specific values are for example purposes and the aspects described are not limited to these specific values.

FIG. 1 illustrates an encoder 100. Variations of this encoder 100 are contemplated, but the encoder 100 is described below for purposes of clarity without describing all expected variations.

Before being encoded, the data sequence may go through pre-encoding processing (110), for example in order to get a signal distribution more resilient to compression. Metadata can be associated with the pre-processing and attached to the bitstream.

In the encoder 100, data is encoded by the encoder elements as described below. The data to be encoded can be partitioned (120) and processed in units of, for example, CUs. Each unit is encoded . The data can be transformed (130) and quantized (140). The quantized (and optionally transform) coefficients, as well other syntax elements, are entropy coded (150) to output a bitstream. The encoder can skip the transform and apply quantization directly to the non-transformed data. The encoder can bypass both transform and quantization, i.e., the data is coded directly without the application of the transform or quantization processes.

FIG. 2 illustrates a block diagram of a decoder 200. In the decoder 200, a bitstream is decoded by the decoder elements as described below. Decoder 200 generally performs a decoding pass reciprocal to the encoding pass as described in FIG. 1. The encoder 100 also generally performs decoding as part of encoding data.

In particular, the input of the decoder includes a bitstream, which can be generated by encoder 100. The bitstream is first entropy decoded (210) to obtain transform coefficients, and other coded information (for instance coded information regarding a number of encoded layers of a DNN and/or an identification of an encoded layer of a DNN). The partition information indicates how data is partitioned. The decoder may therefore divide (220) the data according to the decoded partitioning information. The transform coefficients are de-quantized (230) and inverse transformed (240).

The decoded data can further go through post-decoding processing (250), for example, for performing the inverse of the process performed in the pre-encoding processing (110). The post-decoding processing can use metadata derived in the pre-encoding processing and signaled in the bitstream.

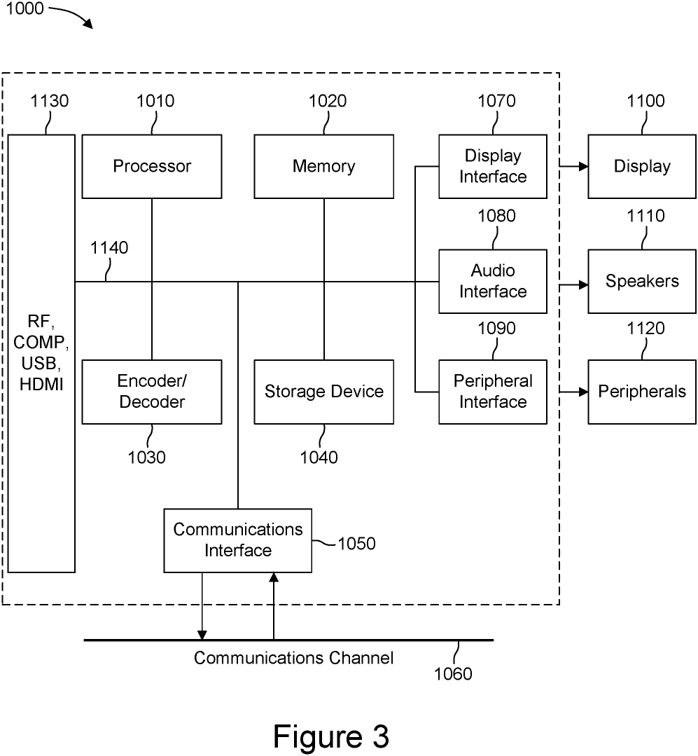

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communication bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random-Access Memory (DRAM), Static Random-Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded DNN layer or decoded DNN layer, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input tensors, decoded tensors or portions of the decoded tensors, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for coding and decoding operations, such as metadata, DNN and/or video related coding and decoding operations such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team), the Open Neural Network eXchange (ONNX) format, the Neural Network Exchange Format (NNEF), Compression of neural networks for multimedia content description and analysis (MPEG-NNR) format, Focus Group on Machine Learning for Future Networks including 5G (ITU FG-ML5G) format or 3rd Generation Partnership Project (3GPP ) format (like the 3GPP specification group TSG-SA (TSG Service and System Aspects).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and bandlimited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing lC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV. Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input data sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, , a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals at least one of a plurality of transforms, coding modes or flags. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
· A process or device to perform obtaining, and/or storing one or more metadata relating a training of a neural network.
· A process or device to perform obtaining, and/or storing one or more metadata relating a training of a deep neural network model as side information of the deep neural network model and/or parameters.
· A process or device to perform encoding and decoding of one or more metadata relating a training of a neural network, to implement metadata compression.
· A process or device to perform encoding and decoding of one or more metadata relating a training of a neural network, to implement deep neural network compression and metadata compression as side information of the deep neural network model and/or parameters..
· A process or device to perform encoding and decoding with inserted information in a bitstream representative of parameters to implement deep neural network compression of a pre-trained deep neural network comprising one or more layers, and metadata related to a prior training of the deep neural network as side information of the deep neural network model and/or parameters.
· A process or device to perform encoding and decoding with inserted information in a bitstream representative of parameters to implement deep neural network compression of a pre-trained deep neural network, and metadata related to a prior training of the deep neural network as side information of the deep neural network model and/or parameters, until a compression criterion is reached.
· A bitstream or signal that includes one or more of the described syntax elements, or variations thereof.
· A bitstream or signal that includes syntax conveying information generated according to any of the embodiments described.
· Creating and/or transmitting and/or receiving and/or decoding a bit stream or signal according to any of the embodiments described.
· A method, process, apparatus, medium storing instructions, medium storing data, or signal according to any of the embodiments described.
· Inserting in the signaling syntax elements that enable the decoder to determine coding mode in a manner corresponding to that used by an encoder.
· Creating and/or transmitting and/or receiving and/or decoding a bitstream or signal that includes one or more of the described syntax elements, or variations thereof.
· A TV, set-top box, cell phone, tablet, or other electronic device that performs transform method(s) according to any of the embodiments described.
· A TV, set-top box, cell phone, tablet, or other electronic device that performs transform method(s) determination according to any of the embodiments described, and that displays (e.g. using a monitor, screen, or other type of display) a resulting image.
· A TV, set-top box, cell phone, tablet, or other electronic device that selects, bandlimits, or tunes (e.g. using a tuner) a channel to receive a signal including an encoded image, and performs transform method(s) according to any of the embodiments described.
· A TV, set-top box, cell phone, tablet, or other electronic device that receives (e.g. using an antenna) a signal over the air that includes an encoded image, and performs transform method(s).

1-15. (canceled)

16. A method performed by a target device, the method comprising:
receiving, from a device on a network, metadata associated with a pre-trained first neural network, wherein the metadata comprises information obtained based on a training of the pre-trained first neural network performed at the device;
obtaining at least a portion of a second neural network from memory at the target device;
adapting the at least the portion of the second neural network based on the metadata associated with the pre-trained first neural network; and
performing an inference during deployment of the adapted second neural network.

17. The method of claim 16, wherein said metadata comprises at least one of: at least one batch size, at least one n-optimizer, at least one drop-out, at least one learning rate, a designation or a parameter of at least one loss function, at least one performance indicator related to an accuracy of training, at least one indicator related to an importance of at least one weight of at least one layer in the first neural network or the second neural network, at least one type of information related to pre-processing performed on at least one element of a training set, or at least one type of information representative of at least one position inside the first neural network where a prediction can be made.

18. The method of claim 16, wherein adapting the second neural network comprises compressing, pruning, or dropping at least a portion of the second neural network based on the metadata.

19. The method of claim 16, wherein the adapting comprises:
splitting at least a portion of the second neural network based on the metadata; and
transmitting at least one split portion of the second neural network.

20. The method of claim 16, wherein said adapting comprises pre-processing at least a part of a training data set based on the metadata, wherein the training data set is configured for use during a training process for fine-tuning the second neural network.

21. The method of claim 16, wherein the metadata is received as compressed metadata that comprises compression of the metadata associated with multiple layers of the first neural network or parameters of at least one tensor associated with the multiple layers of the first neural network, wherein the target device comprises a decoder, and wherein the method comprises decoding the compressed metadata at the decoder.

22. The method of claim 16, wherein the adapting is based on the metadata to meet one or more requirements, wherein the one or more requirements comprise at least one of an accuracy requirement, an energy requirement, a computational requirement, or a memory requirement.

23. The method of claim 16, wherein the adapting comprises picking a sub-part of the second neural network or selecting a set of parameter settings for the second neural network based on the metadata.

24. The method of claim 16, further comprising:
providing a portion of the metadata to a user on a user interface; and
receiving an indication from the user in response to the portion of the metadata being provided, and wherein the adapting is performed based on the indication from the user.

25. The method of claim 16, wherein the metadata indicates an importance of one or more weights in at least one of the first neural network or the second neural network.

26. A target device comprising:
a transceiver;
a memory; and
a processor configured to:
receive, via the transceiver from a device on a network, metadata associated with a pre-trained first neural network, wherein the metadata comprises information obtained based on a training of the pre-trained first neural network performed at the device;
obtain at least a portion of a second neural network from the memory;
adapt the at least the portion of the second neural network based on the metadata associated with the pre-trained first neural network; and
perform an inference during deployment of the adapted second neural network.

27. The target device of claim 26, wherein said metadata comprises at least one of: at least one batch size, at least one n-optimizer, at least one drop-out, at least one learning rate, a designation or a parameter of at least one loss function, at least one performance indicator related to the accuracy of training, at least one indicator related to an importance of at least one weight of at least one layer in the first neural network or the second neural network, at least one type of information related to pre-processing performed on at least one element of a training set, or at least one type of information representative of at least one position inside the first neural network where a prediction can be made.

28. The target device of claim 26, wherein the processor being configured to adapt the second neural network comprises the processor being configured to compress, prune, or drop at least a portion of the second neural network based on the metadata.

29. The target device of claim 26, wherein the processor being configured to perform the adaptation further comprises the processor being configured to:
split at least a portion of the second neural network based on the metadata; and
transmit, via the transceiver, at least one split portion of the second neural network.

30. The target device of claim 26, wherein the processor being configured to perform the adaptation comprises the processor being configured to pre-process at least a part of a training data set based on the metadata, wherein the training data set is configured for use during a training process for fine-tuning the second neural network.

31. The target device of claim 26, wherein the metadata is received as compressed metadata that comprises compression of the metadata associated with multiple layers of the first neural network or parameters of at least one tensor associated with the multiple layers of the first neural network, wherein the target device comprises a decoder, and wherein the decoder is further configured to decode the compressed metadata.

32. The target device of claim 26, wherein the processor is configured to perform the adaptation based on the metadata to meet one or more requirements, wherein the one or more requirements comprise at least one of an accuracy requirement, an energy requirement, a computational requirement, or a memory requirement.

33. The target device of claim 26, wherein the processor being configured to perform the adaptation comprises the processor being configured to pick a sub-part of the second neural network or select a set of parameter settings for the second neural network based on the metadata.

34. The target device of claim 26, wherein the processor is further configured to:
provide a portion of the metadata to a user on a user interface; and
receive an indication from the user in response to the portion of the metadata being provided, and wherein the processor is configured to perform the adaptation based on the indication from the user.

35. The target device of claim 26, wherein the metadata indicates an importance of one or more weights in at least one of the first neural network or the second neural network.
